(19) United States
(12) Patent Application Publication
(10) Pub. No.: US 2016/0202145 A1
(43) Pub. Date: Jul. 14, 2016

(54) CRANK POSITION SENSOR WHEEL AND METHOD FOR MANUFACTURING THE SAME

(71) Applicant: HYUNDAI MOTOR COMPANY, Seoul (KR)

(72) Inventors: ShinGyu KIM, Incheon (KR); Bora LEE, Seongnam-si (KR); Haksoo KIM, Seoul (KR)

(21) Appl. No.: 14/807,487

(22) Filed: Jul. 23, 2015

(30) Foreign Application Priority Data
Jan. 14, 2015 (KR) 10-2015-0007005

(51) Int. Cl. G01M 15/06; B22F 5/00; B22F 3/10

(52) U.S. Cl. CPC G01M 15/06; B22F 3/10; B22F 5/00

(57) ABSTRACT

A crank position sensor wheel comprises a core portion and a surface portion, wherein the surface portion comprises iron and carbon, the surface portion being 0.02% or less by weight carbon, and the core portion comprises iron and carbon, the core portion being between 0.05 and 0.20% by weight carbon.

### CROSS-REFERENCE TO RELATED APPLICATION

This application claims the benefit of priority to Korean Patent Application No. 10-2015-0007005, filed in the Korean Intellectual Property Office on Jan. 14, 2015, the entire content of which is incorporated herein by reference.

### TECHNICAL FIELD

The present disclosure relates to a crank position sensor wheel and a method for manufacturing the same.

### BACKGROUND

A crank position sensor wheel is conventionally manufactured by forming and sintering pure iron powder. The magnetic properties of iron are used to achieve the function of sensing. However, a crank position sensor wheel manufactured as described above is weak to shock or load.

The content of carbon may be increased to improve strength, but when the content of carbon is increased, magnetic properties such as magnetic permeability and flux density steeply decline, so there has been extensive research into overcoming this problem.

The above information disclosed in this Background section is only for the enhancement of understanding of the background of the inventive concept and therefore it may contain information that does not form the prior art that is already known in this country to a person of ordinary skill in the art.

### SUMMARY

The present disclosure has been made in an effort to provide a crank position sensor wheel.

Furthermore, the present disclosure provides a method for manufacturing a crank position sensor wheel.

An exemplary embodiment of the present inventive concept provides a crank position sensor wheel that is divided into a core portion and a surface portion, in which the surface portion includes C at 0.02 wt % or less and the balance composed of Fe and impurities, and the core portion includes C at 0.05 to 0.20 wt % and the balance composed of Fe and impurities.

The surface portion and the core portion may further include Mo at 0.7 to 0.9 wt % and P at 0.4 to 0.5 wt %.

The surface portion may be 200 to 300 mm deep from the outside of the crank position sensor wheel.

The surface portion may have a volume ratio of 95% or more of ferrite.

The core portion may have a volume ratio of 5 to 10% of pearlite.

A value of 3425.09·e^{-17.47}[C]+9272.4·[P]²−7340.16·[P]−757.62·[Mo]+2782.298 may be 1300 or more,

wherein [C] means the wt % of C, [P] means the wt % of P, and [Mo] means the wt % of Mo.

Strength of the crank position sensor wheel may be 450 MPa or more.

Another exemplary embodiment of the present inventive concept provides a method for manufacturing a crank position sensor wheel which includes: forming a metal powder including C at 0.05 to 0.20 wt % and the balance of Fe and impurities; and sintering the formed body in a decarburization atmosphere.

The metal powder may further include Mo at 0.7 to 0.9 wt % and P at 0.4 to 0.5 wt %.

The sintering may be performed in an atmosphere of a carbon potential (cp) of 0.05 v/v %.

The sintering may be performed in an atmosphere of a gas mixture of hydrogen and nitrogen, in which hydrogen in the gas mixture may be 15 to 25 v/v %. The sintering may be performed at 1100 to 1300° C.

In the metal powder, the value of 3425.09·e^{-17.47}[C]+9272.4·[P]²−7340.16·[P]−757.62 [Mo]+2782.298 may be 1300 or more. ([C] means the wt % of C, [P] means the wt % of P, and [Mo] means the wt % of Mo).

The crank position sensor wheel according to an exemplary embodiment of the present inventive concept has excellent strength and magnetic properties.

### BRIEF DESCRIPTION OF THE DRAWINGS

FIG. 1 is a view showing a crank position sensor wheel according to an exemplary embodiment of the present inventive concept.

FIG. 2 is a view showing the structure of a crank position sensor wheel according to an exemplary embodiment of the present inventive concept.

### DETAILED DESCRIPTION

The advantages and features of the present inventive concept and a method of achieving them will be made clear by referring to the exemplary embodiments described below in detail with reference to the accompanying drawings. However, the present inventive concept is not limited to the exemplary embodiments described below and may be implemented in various ways, the exemplary embodiments are provided to complete the present inventive concept and make the scope of the present inventive concept clear to those skilled in the art, and the present inventive concept is defined only by the ranges described in the appended claims. Like reference numerals indicate like constituent elements throughout the specification.

Well-known technologies will not be described in detail in some exemplary embodiments in order to avoid unclear description of the present inventive concept. Unless otherwise defined, all terminologies (including technical and scientific terminologies) used herein may be used with meanings understood by those skilled in the art. Throughout the specification, unless explicitly described to the contrary, the word “comprise” and variations such as “comprises” or “comprising” will be understood to imply the inclusion of stated elements but not the exclusion of any other elements. Further, singular terms include plural terms, unless specifically stated otherwise.

A method for manufacturing a crank position sensor wheel according to an exemplary embodiment of the present inventive concept is described hereafter.

First, a metal powder including C at 0.05 to 0.20 wt % and the balance of Fe and impurities is formed by a press. The metal powder may further include Mo at 0.7 to 0.9 wt % and P at 0.4 to 0.5 wt %.

C is an element capable of improving the strength of a crank position sensor wheel, and when the C content is less than 0.05 wt %, the strength of a crank position sensor wheel decreases, but when it is more than 0.010 wt %, the magnetic properties of a crank position sensor wheel may be deteriorated.

Mo is an element that can improve the hardenability of an iron-based metal, and when the Mo content is less than 0.7 wt %, strength may be decreased, but when it is more than 0.9 wt %, it is less economically efficient.

P is an element capable of improving the strength of a crank position sensor wheel, and when the P content is less than 0.4 wt %, strength and magnetism may be deteriorated, but when it is more than 0.5 wt %, brittleness of a crank position sensor wheel may be increased.

In the metal powder, the value of 3425.09·e^{-17.47[C]}+9272.4·[P]²−7340.16·[P]−757.62·[Mo]+2782.298 may be 1300 or more. When the value of 3425.09·e^{-17.47[C]}+9272.4·[P]²−7340.16·[P]−757.62·[Mo]+2782.298 is less than 1300, the magnetic properties of a crank position sensor wheel may be deteriorated. [C] means the wt % of C, [P] means the wt % of P, and [Mo] means the wt % of Mo.

The methods of manufacturing a metal powder, such as atomizing and milling, have been well known in the art, so detailed description is not provided.

After the forming of the metal powder into the formed body is completed, the formed body is put into a sintering furnace under a decarburization atmosphere and sintered therein.

The sintering furnace may include a preheater, a high-temperature sintering oven, and a cooler.

The preheater may have any temperature in the range of 425 to 1040° C. When the formed body is put in the sintering furnace, it is slowly heated up to the temperature of the preheater. Since the preheater has any one temperature in the range of 425 to 1040° C., it is possible to burn a lubricant on the formed body and improve the reduction of the formed body.

The high-temperature sintering oven may have any temperature in the range of 1100 to 1200° C. The formed body that has been preheated by the preheater is heated up to the temperature of the high-temperature sintering oven. When the temperature of the high-temperature sintering oven is maintained at any one temperature between 1100° C. and 1200° C., the formed body is reduced and decarburized. Thereafter, the formed body is cooled through the cooler.

The formed body takes 60 to 210 minutes to sinter through the high-temperature sintering oven. When the sintering time is less than 60 minutes, the formed body is not sufficiently sintered, but when it is more than 210 minutes, the formed body is excessively sintered and the mechanical properties may be deteriorated.

Further, the atmosphere of the sintering unit may have carbon potential (cp) of 0.05 v/v % or less. It may be an atmosphere of a gas mixture of hydrogen and nitrogen, but hydrogen in the gas mixture of hydrogen and nitrogen may be 15 to 25 v/v %.

The formed body is decarburized through the high-temperature sintering oven, so a decarburization layer is formed to a predetermined depth from the outside of a crank position sensor wheel. The decarburization layer may contain C at 0.02 wt % or less. When the carbon content is more than 0.02 wt %, the sensing characteristic may be deteriorated.

Further, the decarburization layer may have a volume ratio of 95% or more of ferrite. When volume ratio of ferrite is less than 95%, the sensing characteristic may be deteriorated.

The decarburization layer may be 200 to 300 mm deep from the outside surface of the crank position sensor wheel.

The decarburization layer is beneficial for magnetism to flow and magnetic flux generated by the sensor to flow. Accordingly, the characteristic in sensing is improved.

The decarburization layer includes C at 0.05 to 0.20 wt %.

Further, another part except for the decarburization layer may have a volume ratio of 5 to 10% in pearlite.

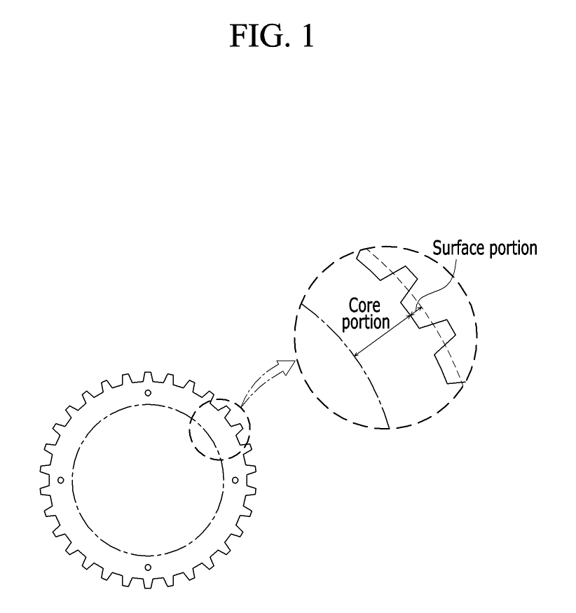

FIG. 1 is a view showing a crank position sensor wheel according to an exemplary embodiment of the present inventive concept.

Referring to FIG. 1, a crank position sensor wheel according to an exemplary embodiment of the present inventive concept is divided into a core portion and a surface portion, in which the surface portion includes C at 0.02 wt % or less and the balance of Fe and impurities.

Further, the core portion includes C at 0.05 to 0.20 wt % and the balance of Fe and impurities.

The surface portion and the core portion may further include Mo at 0.7 to 0.9 wt % and P at 0.4 to 0.5 wt %.

The surface portion may be 200 to 300 mm deep inward from the outside of the crank position sensor wheel.

Further, the surface portion may have a volume ratio of 95% or more of ferrite.

The core portion may have a volume ratio of 5 to 10% of pearlite.

Further, in the crank position sensor wheel, the value of 3425.09·e^{-17.47[C]}+9272.4·[P]²−7340.16·[P]−757.62·[Mo]+2782.298 may be 1300 or more.

The strength of the crank position sensor wheel may be 450 MPa or more.

Hereinafter, the present inventive concept is described on the basis of exemplary embodiments. However, the following exemplary embodiments are only examples of the present inventive concept, and the present inventive concept is not limited to the exemplary embodiments.

### Exemplary Embodiment 1

P 0.45 wt %, Mo: A crank position sensor wheel was manufactured by sintering a powder including P at 0.45 wt %, Mo at 0.85 wt %, and C at 0.1 wt % and was sintered in a decarburization atmosphere.

The formed body was preheated up to 650° C. for total of 60 minutes, heated up to 1200° C. and sintered for a total of 60 minutes in an atmosphere of hydrogen at 20 v/v % and nitrogen at 80 v/v %, and then cooled.

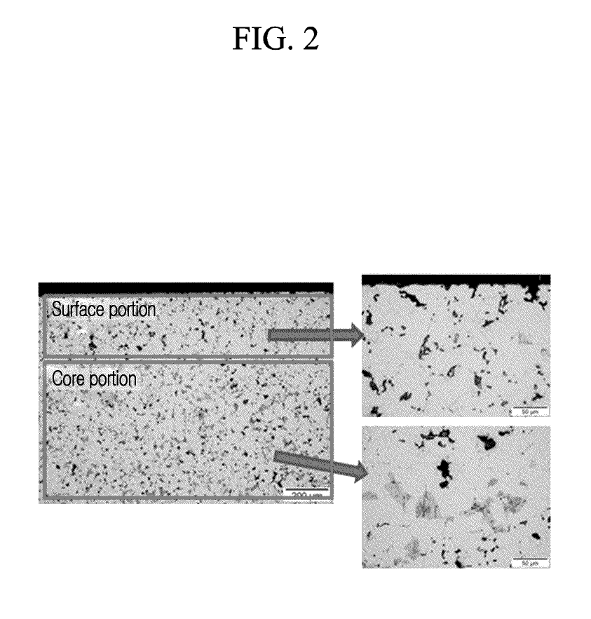

FIG. 2 is a view showing a crank position sensor wheel manufactured by an exemplary embodiment of the present inventive concept. Referring to FIG. 2, it can be seen that the surface portion of the crank position sensor wheel has a volume ratio of 95% or more of ferrite (the white portion is ferrite in FIG. 2). Further, the surface of the crank position sensor wheel had a carbon content of 0.078 wt % because of the decarburization.

The core portion had a carbon content of 0.1 wt. It can be seen that the volume ratio of the core portion is 5 to 10% of pearlite (the brown portion is pearlite in FIG. 2).

Accordingly, the surface portion is good for magnetic flux generated by the sensor to flow, so the characteristic in sensing is improved and the core has a pearlite structure, and thus the strength of the material is improved.

### Exemplary Embodiment 2

A crank position sensor wheel was manufactured by changing the components of powder as in the following Table 1.

TABLE 1

| | | | | | Magnetic properties | | | | |
|---|---|---|---|---|---|---|---|---|---|
| | Component | | | | Jmax | Jr | Hc | | Strength |
| | P (wt %) | Mo (wt %) | C (wt %) | Density | [T] | [T] | [A/m] | μmax | MPa |
| Comparative | X | X | 0.15 | 6.94 | 1.09 | 0.77 | 208 | 1421 | 150 |
| material 1 | | | | | | | | | |
| Comparative | X | X | 0.15 | 7.14 | 1.2 | 0.87 | 213 | 1568 | 200 |
| material 2 | | | | | | | | | |
| Comparative | 0.45 | X | X | 7.3 | 1.42 | 1.19 | 119 | 3882 | 350 |
| material 3 | | | | | | | | | |
| Comparative | 0.45 | X | 0.15 | 7.11 | 1.25 | 0.78 | 191 | 1590 | 385 |
| material 4 | | | | | | | | | |
| Comparative | 0.45 | X | 0.1 | 7.26 | 1.35 | 0.83 | 163 | 1986 | 400 |
| material 5 | | | | | | | | | |
| Exemplary | 0.45 | 0.85 | 0.1 | 7.38 | 1.23 | 0.63 | 197 | 1310 | 472 |
| embodiment | | | | | | | | | |
| Comparative | 0.45 | 0.85 | X | 7.44 | 1.47 | 1.27 | 107 | 4138 | 375 |
| material 6 | | | | | | | | | |
| Comparative | 0.45 | 0.85 | 0.2 | 7.35 | 1.06 | 0.57 | 290 | 817 | 510 |
| material 7 | | | | | | | | | |
| Comparative | 0.45 | X | 0.1 | 7.34 | 1.38 | 0.83 | 166 | 1954 | 410 |
| material 8 | | | | | | | | | |
| Comparative | 0.3 | 0.85 | 0.1 | 7.35 | 1.25 | 0.65 | 192 | 1368 | 390 |
| material 9 | | | | | | | | | |
| Comparative | 0.6 | 0.85 | 0.1 | 7.37 | 1.3 | 0.67 | 164 | 1669 | 445 |
| material 10 | | | | | | | | | |

Referring to Table 1, it can be found that when the contents of P, Mo, and C were in the range of the present inventive concept, excellent magnetic properties and strength were achieved. In Comparative material 10, brittleness was increased in sintering, so the geometric tolerance of the part was difficult to satisfy.

Although exemplary embodiments of the present inventive concept were described above, those skilled in the art would understand that the present inventive concept may be implemented in various ways without changing the spirit or necessary features.

Therefore, the embodiments described above are only examples and should not be construed as being limitative in any respects. The scope of the present inventive concept is determined not by the above description, but by the following claims, and all changes or modifications from the spirit, scope, and equivalents of claims should be construed as being included in the scope of the present inventive concept.

While this inventive concept has been described in connection with what is presently considered to be practical exemplary embodiments, it is to be understood that the inventive concept is not limited to the disclosed embodiments, but, on the contrary, is intended to cover various modifications and equivalent arrangements included within the spirit and scope of the appended claims.

What is claimed is:

1. A crank position sensor wheel comprising a core portion and a surface portion,
wherein the surface portion comprises iron and carbon, the surface portion being 0.02% or less by weight carbon, and
the core portion comprises iron and carbon, the core portion being between 0.05 and 0.20% by weight carbon.

2. The crank position sensor wheel of claim 1, wherein
the surface portion and the core portion further comprise molybdenum at 0.7 to 0.9% by weight and phosphorus at 0.4 to 0.5% by weight.

3. The crank position sensor wheel of claim 2, wherein the surface portion is 200 to 300 mm deep from an outside surface of the crank position sensor wheel.

4. The crank position sensor wheel of claim 3, wherein the surface portion is 95% or more ferrite by volume.

5. The crank position sensor wheel of claim 4, wherein the core portion is 5 to 10% pearlite by volume.

6. The crank position sensor wheel of claim 1, wherein
a value of 3425.09·e^{-17.47}[C]+9272.4·[P]²−7340.16·[P]−757.62−[Mo]+2782.298
is 1300 or more,
where [C] represents the weight percent of carbon, [P] represents the weight percent of phosphorus, and [Mo] represents the weight percent of molybdenum.

7. The crank position sensor wheel of claim 6, wherein strength of the crank position sensor wheel is 450 MPa or more.

8. A method for manufacturing a crank position sensor wheel, comprising steps of:
forming a metal powder comprising iron and carbon, the metal powder being between 0.05 and 0.20% by weight carbon; and
sintering the metal powder in a sintering furnace,
wherein an atmosphere of the sintering furnace has a carbon potential (cp) of 0.05 v/v % or less.

9. The method of claim 8, wherein the metal powder further comprises molybdenum at 0.7 to 0.9% by weight and phosphorus at 0.4 to 0.5% by weight.

10. The method of claim 9, wherein:
the sintering furnace comprises a preheater, a high-temperature sintering oven, and a cooler,
the preheater has a temperature between 425 and 1040° C., and
the high-temperature sintering oven has a temperature between 1100 and 1200° C.

11. The method of claim 8, wherein,
in the metal powder,
the value of 3425.09·e^{-17.47}[C]+9272.4·[P]²−7340.16·[P]−757.62·[Mo]+2782.298
is 1300 or more,
where [C] represents the weight percent of carbon, [P] represents the weight percent of phosphorus, and [Mo] represents the weight percent of molybdenum.
